(19) United States
(12) Patent Application Publication
(10) Pub. No.: US 2008/0067112 A1
(43) Pub. Date: Mar. 20, 2008

(54) METHODS FOR THE RECOVERY OF MOLYBDENUM

(76) Inventor: Martin C. Kuhn, Tucson, AZ (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/533,661

(22) Filed: Sep. 20, 2006

(51) Int. Cl. B03D 1/016; B03D 1/06

(52) U.S. Cl. 209/167

(57) ABSTRACT

A method for the recovery of molybdenum from an ore that includes a molybdenum-bearing mineral, such as molybdenite. The ore is treated to recover metal values from the ore, such as base metals, by utilizing a depressant to depress the flotation of the molybdenite. The tailings, which can include insoluble silicate minerals in addition to the molybdenite, are then activated to render the molybdenite floatable in one or more subsequent flotation steps, thereby producing a high-grade molybdenum concentrate.

### BACKGROUND OF THE INVENTION

1. Field of the Invention

The present invention relates to methods for the recovery of molybdenum in the form of a molybdenum-bearing mineral such as molybdenite utilizing a flotation process. The present invention is particularly applicable to the recovery of molybdenite from ores that include base metal sulfide minerals and that also include insoluble silicate minerals.

2. Description of Related Art

Molybdenum in the form of molybdenite (MOS₂) occurs in ores that also include base metal sulfides, such as copper-bearing sulfides. During flotation of a pulp (slurry) to concentrate the metal values contained in the ore, the molybdenite floats out with the base metal minerals. Although the base metal may be the primary value in the ore, significant quantities of molybdenite can also be present and recovery of the molybdenite in an economically feasible fashion is desirable.

Base metal sulfide minerals and molybdenite also typically occur in an ore body with gangue minerals, such as insoluble silicates. The base metal sulfides, molybdenite and silicates all naturally float to some degree due to the hydrophobic nature of the mineral surface. Gangue minerals are undesirable in the ore concentrate, and therefore it is known to depress the flotation of the gangue minerals by conditioning the pulp with selected reagents prior to and/or during flotation. However, such reagents may depress the flotation of the molybdenite, which is then mixed with the insoluble gangue minerals and is difficult to economically separate from the gangue minerals.

U.S. Pat. No. 2,255,776 by Janney et al. discloses the separation of molybdenite from a base metal ore body and gangue materials by froth flotation. An ore concentrate including molybdenite, copper sulfides and/or iron sulfides and gangue materials is subjected to an aging treatment to depress the floatability of the sulfides other than molybdenite, such that the molybdenite can be selectively recovered by flotation. The aging treatment can include heating in an oxidizing atmosphere, atmospheric drying, steaming, boiling in water, and the like. When gangue minerals are present, the aged pulp can be subjected to a first flotation at a low pH to float the gangue minerals and a subsequent flotation at a higher pH to float the molybdenite, leaving the base metal sulfides in the tailings.

U.S. Pat. No. 3,912,623 by Buza et al. discloses a flotation method for the recovery of molybdenite from molybdenum concentrates. The method includes treating a molybdenum concentrate with lignin sulfonate at pH 10 or higher and subjecting the treated concentrate to froth flotation to float the copper sulfides, iron sulfides and insolubles, and increase the molybdenum concentration in the tailings.

U.S. Pat. No. 3,921,810 by Huch discloses a method of separating an ore containing both molybdenite and a silicate gangue mineral by utilizing an aqueous pulp of the ore that includes a water soluble metallic salt of a weak base and a strong acid, and a water soluble alkali metal, water soluble alkaline earth metal or water soluble ammonium salt of a weak acid. The aqueous pulp is subjected to flotation where the molybdenite is floated and the naturally hydrophobic silicate is depressed into the tailings.

U.S. Pat. No. 4,549,959 by Armstrong et al. discloses a process for separating molybdenite from a molybdenite-containing copper sulfide concentrate by flotation. The molybdenite is selectively floated by use of a sulfite or bisulfite compound as a depressant for the copper sulfide mineral. Gangue minerals can be removed in a first rougher flotation step.

U.S. Pat. No. 4,853,114 by Lewis et al. discloses a method for the beneficiation of value minerals from an ore that includes hydrous, layered silicates by utilizing a cellulose compound to selectively depress the silicates and selectively float the value minerals. It is disclosed that the value minerals can include copper-molybdenum ores.

U.S. Pat. No. 5,030,340 by Panzer et al. discloses a method for depressing the flotation of silicates such as talc utilizing dihydroxyalkyl polysaccharides. It is disclosed that the method can be used to separate silicates from a variety of ores, including copper-molybdenum ores.

U.S. Pat. No. 5,068,028 by Miller et al. discloses a process for recovering molybdenite from feed materials containing copper sulfide and molybdenite, where the feed material is treated with ozone for a period of time to render the copper sulfide surfaces hydrophilic. The feed material is then floated to recover molybdenite and remove copper sulfide in the tailings. Silicates can be removed in a prior flotation circuit, however it is also disclosed that a further ozone treatment can be used to depress molybdenite flotation so that molybdenite can then be separated from silicate impurities.

There remains a need for an economically efficient method to recover molybdenite from ores, particularly ores that include base metal minerals and include insoluble silicate minerals.

### SUMMARY OF THE INVENTION

Accordingly, the present invention provides a method for the separation and recovery of a molybdenum-bearing mineral such as molybdenite from a mineral ore body. According to one embodiment, the method can include the steps of providing a mineral ore body that includes a base metal mineral and a molybdenum-bearing mineral and forming the mineral ore body into an ore concentrate. The mineral ore concentrate is subjected to base metal flotation in the presence of a molybdenum depressant, where the depressant depresses the flotation of the molybdenum-bearing mineral in the base metal flotation step. Tailings are recovered from the base metal flotation step where the tailings include the molybdenum-bearing mineral.

According to the present invention, the tailings are then activated where the activating step changes a surface property of the molybdenum-bearing mineral, enabling the molybdenum-bearing mineral to be separated by flotation. The activated base-metal flotation tailings are then subjected to a molybdenum flotation step where the activated molybdenum-bearing mineral is floated to form a first molybdenum mineral concentrate.

The first molybdenum mineral concentrate can be subjected to a second molybdenum flotation step to separate silicates from the first molybdenum mineral concentrate and form a second molybdenum mineral concentrate, from which molybdenum values can subsequently be recovered. The second molybdenum flotation step can occur at a reduced pH, such as not greater than about pH 3. In one embodiment, a sulfur-containing acid can be added to the first molybdenum mineral concentrate to reduce the pH.

The second molybdenum flotation step can be followed by treating the second molybdenum mineral concentrate to further separate silicate minerals from the molybdenum mineral concentrate. In one embodiment, the concentrate is subjected to roasting in the presence of an oxygen-containing gas to oxidize the molybdenum bearing mineral, and the roasted concentrate is then subjected to a third flotation step whereby silicate minerals are floated and separated from the molybdenum-bearing mineral.

The base metal mineral can be a copper sulfide mineral, and in one embodiment is selected from the group consisting of chalcocite, covellite, bornite, enargite, tennanite, tetrahedrite, digenite, chalcopyrite and combinations thereof. The mineral ore body can be formed into an ore concentrate by comminuting the ore body and subjecting the comminuted ore body to rougher flotation. The molybdenum depressant can be a polysaccharide, such as carboxy methyl cellulose. In one embodiment, the depressant is sodium carboxy methyl cellulose. The activating step can include heating the base metal flotation tailings in water, such as at a temperature of at least about 40° C., such as at least about 65° C. and not greater than about 95° C. The heating can advantageously occur at ambient pressure.

The molybdenum-bearing mineral will typically include molybdenite (MOS₂). The mineral ore body will typically also include gangue minerals, typically silicate minerals and in one embodiment will include a magnesium-containing silicate mineral such as talc. For example, in one embodiment, the mineral ore body can include at least about 4 wt. % silicate minerals.

According to another embodiment of the present invention, a method for the recovery of molybdenite from a mineral ore body is provided. An ore concentrate formed from the mineral ore body is provided that includes a base metal sulfide mineral, molybdenite and a silicate mineral. The ore concentrate is subjected to a base metal flotation step in the presence of a depressant, where the depressant depresses flotation of the silicate mineral and the molybdenite. Tailings are recovered from this base metal flotation step where the tailings include the molybdenite and the silicate mineral. The tailings are then activated where the activating step enables the molybdenite to be floated. The activated tailings are then subjected to a first molybdenum flotation step where molybdenite is separated from the base metal tailings to form a molybdenite first molybdenum concentrate. The pH of the first molybdenum concentrate is then reduced and the concentrate is subjected to a second molybdenum flotation step to form a second molybdenum concentrate from which molybdenum values can be recovered.

### DESCRIPTION OF THE DRAWINGS

FIG. 1 is a process flow sheet illustrating a method according to an embodiment of the present invention.

### DESCRIPTION OF THE INVENTION

The present invention relates to a method for the recovery of molybdenum in the form of a molybdenum-bearing mineral, particularly a molybdenum sulfide mineral such as molybdenite (MOS₂). Although the present invention is applicable to the recovery of any molybdenum-bearing mineral, particularly a sulfide-bearing molybdenum mineral, for simplicity the present invention will be described with respect to the recovery of molybdenite.

The method includes subjecting an ore to a series of mineral processing steps that liberate metal values from the ore. The method of the present invention is applicable to a variety of ore bodies that include molybdenite. According to one preferred embodiment, the ore body includes molybdenite and a base metal mineral, such as a copper-bearing mineral or a nickel-bearing mineral.

The present invention is particularly applicable to a mineral ore body that also includes one or more copper-bearing minerals, particularly a copper sulfide mineral. Such copper-bearing minerals can include, but are not limited to, chalcocite (Cu₂S), covellite (CuS), bornite (Cu₅FeS₄), enargite (Cu₃AsS₄), tennantite ((Cu,Fe)₁₂AS₄S₁₃), tetrahedrite (Cu₁₂Sb₄S₁₃), digenite (C₉S₅), chalcopyrite (CuFeS₂) and mixtures thereof. In addition, the ore body can include additional sulfide minerals such as sphalerite (ZnS), marmatite ((Zn, Fe)S), pyrite (FeS₂), galena (PbS), phyrrotite (FeS), pentlandite ((Fe,Ni)₉S₈) and millerite (NiS).

The present invention is particularly applicable to a mineral ore body that also includes appreciable amounts of insoluble gangue minerals, particularly insoluble silicate minerals. Such gangue minerals can include quartz, clays, micas, feldspars, phlogopite, biotite (sericite), chlorite, talc (Mg₃Si₄O₁₀(OH)₂) and other layered silicates. According to one embodiment, the mineral ore body includes at least about 4 wt. % insoluble silicate minerals. As is discussed in detail below, the present invention advantageously provides for the recovery of a high quality base metal concentrate and a high quality molybdenum concentrate with a substantial quantity of the gangue minerals separated from the metal concentrates.

According to the present invention, the mineral ore body is first subjected to a base metal flotation circuit to separate the base metal minerals from the molybdenite and silicate gangue minerals. Prior to flotation, the raw mineral ore body can be formed into an ore concentrate. For example, the mineral ore body can be comminuted to reduce the particle size of the ore, which enables the ore particles to be floated and facilitates the recovery of metal values from the ore. For example, the ore can be ground such that 80 wt. % of the ore passes through a 150 mesh screen. Reagents can optionally be added to the grinding step, such as a dispersant, and in one embodiment sodium silicate is added to the grinding step as a dispersant.

The comminuted ore body can be initially slurried with a liquid aqueous medium to form a pulp, such as one having a solids loading (pulp density) of at least about 25 wt. % and not greater than about 55 wt. %. Operating in this pulp density range throughout the flotation steps of the present invention has been shown to produce a high quality base metal concentrate, and also a high quality molybdenum concentrate from the base metal flotation tailings. Operating at higher pulp densities may decrease the quality (i.e., the concentration of the metal) in the concentrates.

The ore body pulp can first be subjected to a rougher flotation step where all floatable minerals are separated from the non-floatable minerals to form an ore concentrate. The ore concentrate recovered from the rougher flotation, which includes the molybdenite, can then be provided to a base metal flotation circuit.

The ore concentrate pulp can be treated after the rougher flotation to reduce the solids loading in the pulp as compared to the rougher flotation step, which can enhance recovery in the subsequent cleaner flotation steps. Further, the rougher concentrate can optionally be reground to further reduce the particle size of the concentrate before being subjected to cleaner flotation steps, discussed below.

The base metal flotation circuit subjects the ore concentrate to a series of flotation steps for the recovery of base metals in a high-grade base metal concentrate. In the base metal flotation circuit, and the subsequent molybdenum flotation circuit, the concentrate can be conditioned in a conditioning step prior to flotation, wherein flotation reagents are added to facilitate the separation and recovery of the desired minerals from the ore body. Such reagents can include collectors, promoters, frothers, pH adjusters, depressants, activators and the like. By way of example, promoters and collectors can be added such as xanthates, thiophosphates, thiocarbamates, mercaptans, thioureas, mercaptobenzothiazoles, alkoxycarbonyl thionocarbamates, xanthogen formates and xanthate allyl esters. Frothers can be added such as MIBC, AEROFROTH 65, AEROFROTH F-507, OREPREP F-507, and AEROFROTH 70 (all available from Cytec Industries, West Patterson, N.J., USA). pH adjusters can be added such as milk of lime, potassium hydroxide or sodium hydroxide, soda ash, calcium carbonate, sulfuric acid, sulfurous acid and hydrochloric acid. Depressants can be added such as cyanide, ferrocyanide, sulfoxy species, sodium silicate, zinc sulfate, dichromates, sodium sulfide and hydrosulfide, Nokes Reagent, permanganate and other oxidizing agents. Natural organic depressants can be added such as quebracho, lignin sulfonates, dextrin, starches, carboxy methyl cellulose (CMC) and guar gum, and AERO 633 (starch). Also, activators can be added such as copper sulfate, lead nitrate, lead acetate, sodium hydrosulfide and sodium cyanide.

The method of the present invention subjects the ore concentrate to a base metal flotation circuit that includes one or more cleaner flotation steps in the presence of a molybdenite depressant that depresses flotation of the molybdenite and forms a high-grade base metal concentrate. Preferably, the molybdenite depressant is a polysaccharide. Polysaccharides advantageously depress various minerals in the pulp during the cleaning flotation step(s). Polysaccharides such as carboxyl methyl cellulose (CMC), dextrin and guar gums adsorb on the surface of naturally floating minerals, effectively turning a hydrophobic surface (non-wetting, and therefore floatable) to a hydrophilic surface (wetting, and therefore not floatable). A particularly preferred molybdenite depressant according to the present invention is sodium CMC.

The molybdenite depressant is preferably added to at least one of the cleaner flotation steps in an amount sufficient to depress flotation of at least a portion of the molybdenite. Accordingly, it is preferred to add at least about 15 g/tonne (grams molybdenite depressant per tonne of solid ore), and not greater than about 240 g/tonne of the molybdenite depressant. In this regard, it is found that lower levels of depressant, such as at least about 15 g/tonne and not greater than about 40 g/tonne, can be effectively utilized when the mineral ore body has relatively low levels of naturally floatable silicates such as talc. When the ore body includes higher levels of such silicates, higher levels of depressant are preferably used, such as at least about 100 g/tonne, more preferably at least about 140 g/tonne of the depressant. When multiple cleaner flotation steps are utilized, the concentration of molybdenite depressant that is added can preferably be decreased with each subsequent flotation step. However, a first cleaner flotation step (after the rougher flotation) is preferably utilized prior to introduction of the molybdenite depressant to remove iron sulfides, such as pyrite, and non-flotating gangue minerals from the concentrate.

Although the molybdenite depressant advantageously causes the molybdenite to report to the tailings of the base meal flotation circuit, it has been found that the addition of a molybdenite depressant such as a polysaccharide also depresses the flotation of the gangue minerals, particularly the insoluble silicates such as talc. Thus, the base metal concentrate that is recovered from the base metal flotation circuit advantageously has a high concentration of the base metal and has a low concentration of the molybdenite, as well as a low concentration of insoluble gangue minerals.

According to the present invention, the tailings from the base metal flotation circuit are subjected to further mineral processing to produce a high-grade molybdenite concentrate, from which molybdenum can be economically recovered.

In this regard, the tailings from the base metal flotation circuit are recovered and are subjected to an activation step to cause the molybdenite to be floatable. In the activation step, a surface property of the molybdenite is changed, such as changing the surface of the molybdenite from a hydrophilic state to a hydrophobic state. This will enable the molybdenite to be floated. The activation step will typically include the removal, degradation or coating of the depressant on the surface of the molybdenite. A substantial portion of the gangue minerals that are also present in the tailings from the base metal flotation circuit will preferably not be activated by the activation step so that these minerals can be removed in the tailings.

Preferably, the activation step includes heating the tailings in an aqueous liquid medium for a period of time sufficient to return at least a portion of the molybdenite in the tailings to its naturally floating state. Typically, the tailings will be contacted with the aqueous liquid medium for at least about 15 minutes and not greater than about 60 minutes. Preferably, the temperature of the aqueous liquid medium is at least about 40° C., more preferably is at least about 65° C. and even more preferably is at least about 80° C. When the activation occurs at ambient pressure conditions, the temperature preferably is not greater than about 95° C. If a pressure above atmospheric pressure is used, such as in an autoclave, increased temperatures can be used. The aqueous liquid medium can consist essentially of water or can include additives such as flocculants to enhance settling of the tailings.

Although the activation step preferably includes heating the tailings in water, other techniques that remove, modify or coat the depressant on the surface of the molybdenite can be useful as well. For example, the tailings could be subjected to ultrasonic energy to remove the depressant from the molybdenite surface. A method and apparatus for treating a pulp using an ultrasonic energy are disclosed in U.S. Pat. No. 4,556,467 by Kuhn et al., which is incorporated herein by reference in its entirety. Other activation methods could include the addition of a molybdenum collector, such as fuel oil, to coat the depressant on the surface of the molybdenite.

The activated tailings from the activation step are then subjected to a first molybdenum flotation step (i.e., a molybdenum rougher flotation step) to float the activated molybdenite and any gangue minerals that are also rendered floatable by the activation step and form a first molybdenum mineral concentrate. This molybdenum mineral concentrate can also include minor amounts of common sulfide minerals that were rejected in the tailings from the base metal flotation circuit. A collector such as fuel oil can be added to this first molybdenum flotation step, if desired, to enhance flotation of the sulfide minerals, such as the molybdenite and copper sulfide minerals. The first molybdenum flotation step can also include the addition of, for example, a frother, or other additives.

The tailings from the first molybdenum flotation step can optionally be recycled back to the base metal flotation circuit, such as by recycling the tailings to the base metal rougher flotation step (before or after grinding), or to the rougher concentrate regrind step. This advantageously allows for the recovery of any unfloated metal values, such as copper metal values, that were undesirably rejected with the tailings from the base metal flotation circuit.

Before recycling the tailings from the first molybdenum flotation step to the base metal flotation circuit, the tailings can be subjected to a scavenger flotation step for the concentration of the remaining metal values. The scavenger flotation can include adjusting the pH if necessary, and adding flotation reagents to float desired metal values from the depressed silicate minerals. The scavenged metal values can then be recycled to the base metal flotation circuit and the tailings can be disposed.

The molybdenum mineral concentrate from the first molybdenum flotation step can be subjected directly to known processes for the recovery of molybdenum metal, particularly if the mineral ore body has a relatively low concentration of silicate minerals. However, if the mineral ore body has a relatively high concentration of silicate minerals, the molybdenum mineral slurry recovered from the first molybdenum flotation step can still include appreciable amounts of silicate minerals. To improve the quality of the molybdenum mineral concentrate (i.e., to increase the molybdenum concentration), the molybdenum mineral concentrate is preferably subjected to further mineral processing.

In this regard, the molybdenum mineral concentrate recovered from the first molybdenum flotation step can be subjected to additional flotation steps to further improve the quality of the molybdenum concentrate. The concentrate pulp from the first molybdenum flotation step will typically have a pH of from about pH 7 to about pH 10. To facilitate flotation to separate additional silicate minerals, the concentrate can be subjected to a conditioning step to reduce the pH of the concentrate. For example, an acid, preferably a sulfur-containing acid such as sulfuric acid or sulfurous acid, can be added to the pulp to decrease the pH. Preferably, the pH is decreased to not greater than about pH 3, and more preferably not greater than about pH 2, such as from about pH 1.3 to pH 1.9.

After a sufficient reaction time in the conditioning step to lower the pH, the pH-adjusted molybdenum mineral concentrate can be subjected to a second molybdenum flotation step, where additional molybdenite is floated and recovered. The tailings from the second molybdenum flotation step will include mostly silicates and can be disposed to waste. The recovered second molybdenum mineral concentrate from the second molybdenum flotation step can then be subjected to known processes for the recovery of molybdenum metal if the concentration of silicate minerals is sufficiently low and the molybdenite concentration is sufficiently high.

However, when the mineral ore body contains a high level of silicates such as talc, it may be desirable to further treat the concentrate from the second molybdenum flotation step to separate additional silicates from the molybdenite. For example, the concentrate from the second molybdenum flotation step can be subjected to a roasting step in an oxidizing atmosphere to oxidize the molybdenite and therefore render the molybdenite hydrophilic (non-floatable), while the silicates remain hydrophobic and therefore will be floatable. For example, the second molybdenum mineral concentrate from the second molybdenum flotation step can be roasted in an oxidizing atmosphere such as air at a temperature of at least about 450° F. and not greater than about 500° F. for about 30 minutes. The roasting step will remove the remaining cellulose depressant from the surface of the molybdenite, will oxidize the surface of the molybdenite and oxidize any other sulfide minerals such as copper sulfide minerals.

Thereafter, the roasted molydenite concentrate can be subjected to flotation at about pH 7 whereby silicate minerals will float and separate from the molybdenite. Due to the roasting step, the tailings from this flotation step will be a high quality concentrate that includes molybdenite and other base metal sulfides. These tailings can be subjected to known processes for the recovery of molybdenum. Alternatively, the tailings can be subjected to a fourth molybdenum flotation step at about pH 9 to further improve the quality of the molybdenum concentrate. The tailings from the fourth molybdenum flotation step can be recycled back to the base metal flotation circuit for additional recovery of base metal values.

The molybdenite concentrate that is recovered from the fourth flotation step can be treated using known processes for the recovery of molybdenum, such as roasting the concentrate to form molybdenum oxide.

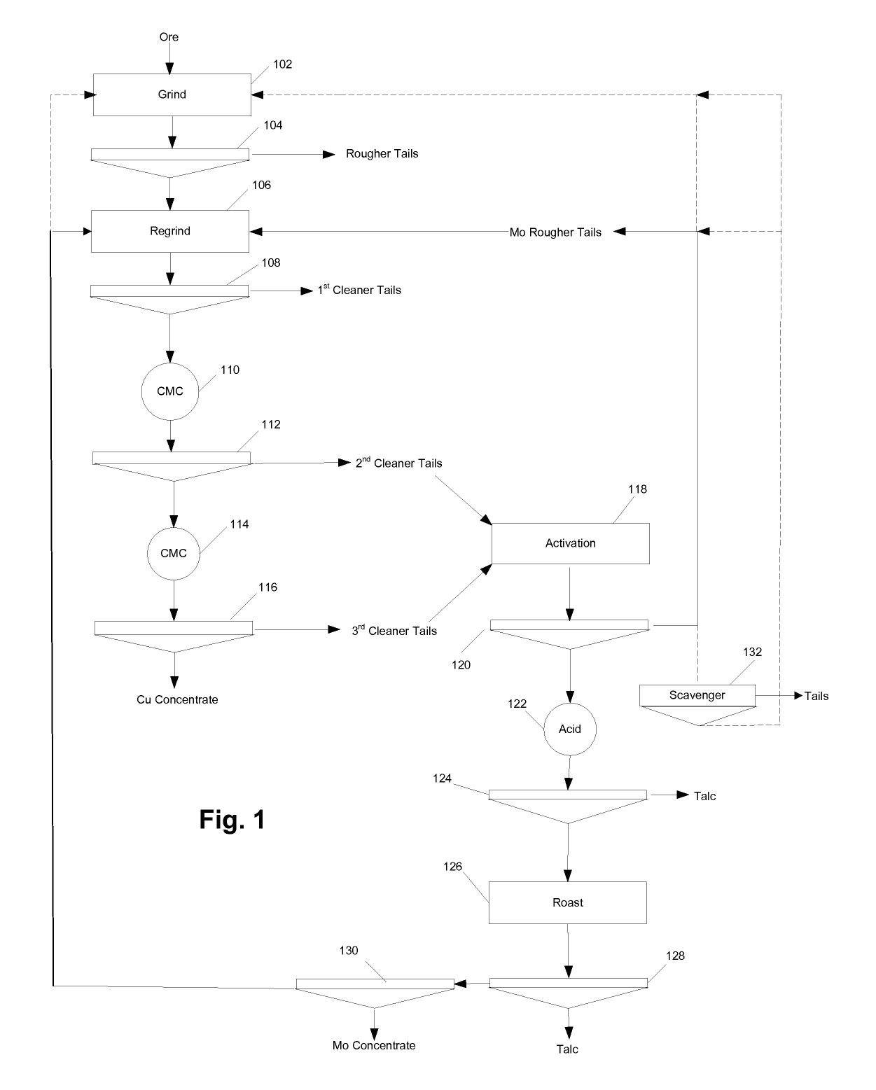

One preferred process according to the present invention is illustrated in the flow sheet of FIG. 1. Referring to FIG. 1, an ore body is provided to a grinding step 102 where the ore is ground such that about 80 wt. % of the ore passes through a predetermined screen size consistent with the ore's mineral liberation characteristics. In one embodiment, the ore is ground such that 80 wt. % of the ore passes through a 150 mesh screen. The ground ore is then provided to a rougher flotation step 104 in the form of a pulp having a solids loading of from about 35 wt. % to about 45 wt. %. Additives such as AEROFLOAT-238, potassium amyl xanthate (PAX), diesel fuel and others can be added to the rougher flotation 104, which is carried out at a predetermined pH, such as about pH 10.5. In the rougher flotation 104, the floatable minerals such as base metal sulfides and molybdenite are separated from non-floatable minerals to form an ore concentrate.

The rougher concentrate is then provided to a regrind step 106 where the particle size of the ore is further reduced prior to cleaner flotation. As is discussed above, additional reagents can be added during or after the regrind step 106, as may be desirable.

The ore concentrate is then provided to a first cleaner flotation step 108. The first cleaner flotation step 108 does not include the use of a depressant for the molybdenite so that molybdenite is not depressed in the first cleaner flotation. The first cleaner flotation can include a depressant for iron-sulfide minerals such as pyrite. For example, milk of lime can be added to the first cleaner flotation 108 to depress pyrite and the flotation can be carried out at about an appropriate pH value, such as about pH 11.5. The first cleaner tails from this step can be disposed, as they include mostly iron sulfide minerals such as pyrite and non-floating gangue minerals.

The ore concentrate from the first cleaner flotation 108 is then subjected to a first conditioning step 110 where carboxy methyl cellulose (CMC) is added to the ore concentrate for the depression of floating silicate minerals and molybdenite. Other reagents can be added, as is discussed above. The ore concentrate is then subjected to a second cleaner flotation step 112. The concentrate from the second cleaner flotation step 112 is then subjected to a second conditioning step 114 where additional CMC is added to the ore concentrate, where the concentration of the CMC added in the second conditioning step 114 can be lower than the concentration of CMC in the first conditioning step 110.

Thereafter, if necessary, the ore concentrate is provided to a third cleaner flotation step 116 and a copper concentrate is recovered from the third cleaner flotation step 116. The copper concentrate is a high-quality copper concentrate having a high concentration of copper and a relatively low concentration of molybdenite and of silicate minerals, due to the use of CMC during flotation. Additional cleaner flotation steps can be utilized if desired for a given mineral ore body.

The tails from the second cleaner flotation step 112 and the third cleaner flotation step 116, which include molybdenite, are then each provided to an activation step 118 where the tailings are contacted with water at a temperature of from about 60° C. to about 90° C. for a sufficient amount of time to activate flotation of the molybdenite in the tailings. For example, the contact time can be from about 15 minutes to 60 minutes.

The tailings from the activation step 118 are then provided to a molybdenum rougher flotation step 120. The molybdenum rougher flotation 120 is carried out at a pH of from about pH 7 to pH 8.5 to form a first molybdenum concentrate. The tailings from the molybdenum rougher flotation step 120 can be provided back to the base metal flotation circuit for additional recovery of copper metal values that were carried out in the second and third cleaner tails and any molybdenum that was not activated by the activation step 118. A scavenger flotation step 132 can be utilized to provide a scavenger concentrate for recycle back to the base metal flotation circuit and the scavenger tailings can be disposed to waste.

The first molybdenum concentrate from the molybdenum rougher flotation step 120 is then subjected to a pH adjusting step 122 where sulfuric acid (H₂SO₄) may be added to the molybdenum concentrate to decrease the pH to from about pH 1.3 to about pH 1.9. Thereafter, the pH-adjusted molybdenum concentrate is subjected to a molybdenum cleaner flotation step 124 to separate molybdenum values from the gangue minerals and form a second molybdenum concentrate. Tailings from the molybdenum cleaner flotation 124 will include a large quantity of insoluble gangue minerals such as talc and can be disposed to waste.

The concentrate from the molybdenum cleaner flotation step 124 can then be subjected to a roasting step 126. The roasting step can include heating the concentrate in an oxidizing atmosphere such as air at a temperature of from about 450° F. to about 500° F. (about 230° C. to about 260° C.) for a period of time sufficient to oxidize the surface of the molydenite.

After roasting, the roasted concentrate is reformed into a pulp and is provided to a further molybdenum cleaner flotation step 128 whereby the silicate minerals such as talc are floated from the molybdenite and other sulfide minerals, which are depressed due to their oxidized surfaces. The floated talc can be disposed to waste. The tailings concentrate including molybdenite and other sulfide minerals can be provided to a further cleaner flotation step 130 where flotation occurs at about pH 9 to form a high-grade molybdenum concentrate.

### EXAMPLES

In each of the following examples, the following general process parameters for the molybdenum recovery method of the present invention are utilized.

The mineral ore bodies include at least a copper mineral, molybdenite and talc. For the initial copper recovery circuit, each sample (mineral ore body) is ground such that 80 wt. % of the ore body passes 150 mesh. The ground mineral body is then subjected to a rougher flotation step. The rougher flotation is carried out at 35 to 45 wt. % solids loading (pulp density), with the addition of about 12 g/tonne AEROFLOAT-238 (a promoter), about 10 g/tonne potassium amyl xanthate (PAX) and about 19 g/tonne diesel at pH 10.5. The laboratory rougher flotation time is about 10 minutes. From about 47 to 100 g/tonne of AEROFROTH AF-65 (a frother available from American Cyanamid) and from about 34 to 72 g/tonne of methyl isobutyl carbinol (MIBC) are also added to the rougher flotation.

A low-grade ore concentrate is recovered from the rougher flotation and is reground. The reground ore concentrate is then subjected to a first cleaner flotation at pH 11.5 for 7 to 18 minutes with the addition of milk of lime (a depressant for pyrite). The concentrate is then subjected to a second cleaner flotation at pH 11.8 for 6 to 12 minutes in the presence of from about 25 to 140 g/tonne of 7M carboxy methyl cellulose (CMC). Thereafter, the concentrate is subjected to a third cleaner flotation step at pH 11.8 for 5 to 12 minutes in the presence of from about 25 to 80 g/tonne 7M CMC.

The tailings from the copper recovery circuit, which include molybdenum values, are subjected to an activating step by placing the tailings in water at a temperature of 85° C. for 30 minutes. Thereafter, the tailings are subjected to a first molybdenum flotation step (Mo rougher flotation) at from about pH 7 to pH 8.5 for about 6 to 9 minutes at ambient temperature. The resulting molybdenum concentrate is then conditioned by adding from about 310 to 2230 g/tonne of sulfuric acid (H₂SO₄) to lower the pH to about pH 1.4 to pH 1.8. The conditioned concentrate is then subjected to a second molybdenum flotation step (Mo cleaner flotation) for 5 to 7 minutes in the presence of 1 to 5 g/tonne PAX. The recovered Mo concentrate is then subjected to a final flotation step (Mo scavenger flotation) at from about pH 1.3 to pH 1.9 for about 3 to 5 minutes.

For purposes of comparison, each mineral body sample is also subjected to a conventional locked cycle flotation test. A locked cycle test consists of a series of batch tests where the concentrate products recovered in a flotation circuit are recycled back to a cleaner flotation step for further concentration. The circuit initially includes a rougher flotation, three cleaner flotation steps, and a scavenger flotation step. The concentrate from the scavenger flotation is then provided back to the cleaner flotation circuit for another pass through the three cleaner flotation steps and the scavenger flotation. The circuit is run for a total of 6 passes through the cleaner flotation circuit in order for the recycling materials to approach equilibrium before the concentrate is removed and analyzed. The liquid used for flotation is also recycled so that the reagents build in concentration.

### Example 1

The relevant composition of the mineral body sample for Example 1 is illustrated in Table 1.

TABLE 1

Assay
(wt. %)

| | Cu | Mo | Fe | Mg |
|---|---|---|---|---|
| Example 1 | 0.64 | 0.013 | 6.35 | 1.70 |

The copper and molybdenum contents in this mineral body are close to the average for the mineral bodies evaluated in these examples. For purposes of comparison, the final analysis of the recovered concentrate when the mineral body of Example 1 is subjected to the locked cycle test is illustrated in Tables 2 and 3.

TABLE 2

| | Cu/Mo Concentrate | | |
|---|---|---|---|
| | Analysis (wt. %) | | |
| | Cu | Mo | Insolubles |
| Example 1 | 25.99 | 0.493 | 7.24 |

TABLE 3

Final Cu/Mo
Concentrate
(wt. %
Recovery)

| | Cu | Mo |
|---|---|---|
| Example 1 | 89.46 | 67.28 |

About 89.5 wt. % of the available copper and about 67.3 wt. % of the available molybdenum is recovered in a concentrate that includes about 26 wt. % copper, about 0.5 wt. % molybdenum and about 7.2 wt. % insolubles (e.g., gangue minerals).

The mineral body is also subjected to the method of the present invention. The dosage of CMC in the 2^{nd} and 3^{rd} cleaner flotation steps is 125 g/tonne. The results are illustrated in Tables 4 and 5.

TABLE 4

| | Analysis (wt. %) | | | | | |
|---|---|---|---|---|---|---|
| | | | 1st | | | |
| | Final | | Cleaner Mo | | Mo Rougher Tail | |
| | Cu Concentrate | | Concentrate | | to Process Recycle | |
| | Cu | Mo | Cu | Mo | Cu | Mo |
| Example 1 | 39.9 | 0.029 | 5.01 | 2.17 | 7.2 | 1.1 |

TABLE 5

| | Distribution (wt. %) | | | | | |
|---|---|---|---|---|---|---|
| | | | 1st | | | |
| | Final | | Cleaner Mo | | Mo Rougher Tail | |
| | Cu Concentrate | | Concentrate | | to Process Recycle | |
| | Cu | Mo | Cu | Mo | Cu | Mo |
| Example 1 | 78.95 | 1.97 | 3.68 | 55.64 | 6.92 | 36.25 |

The copper grade in the copper concentrate is higher for the method of the present invention than for the locked cycle test (39.9 wt. % vs. 26 wt. %), primarily due to the addition of CMC to depress flotation of MOS₂ and insolubles in the copper flotation circuit.

The copper concentrate initially recovered from the copper flotation circuit using the method of the present invention includes about 79 wt. % of the available copper, as compared to about 89.5 wt. % of the available copper recovered in the locked cycle test. However, the copper from the first cleaner molybdenum concentrate (3.68 wt. %) and from the molybdenum rougher tail (6.92 wt. %) can be recycled back to the copper cleaner flotation circuit (see FIG. 1) and most of the available copper in these feeds (about 10.5 wt. % total for Example 1) can be recovered, resulting in a final copper recovery that is at least comparable to the locked cycle test.

Applying the method of the present invention, a very small portion of the molybdenum value is lost with the initial copper concentrate. About 55.6 wt. % of the available molybdenum is recovered in the first cleaner molybdenum concentrate. In addition, the molybdenum rougher tailing (containing about 36.3 wt. % of the available molybdenum) can be recycled back to the copper flotation circuit (see FIG. 1), eventually resulting in the recovery of most of that molybdenum. Therefore, the total molybdenum recovery for this Example 1 can approach 85 wt. % to 90 wt. % of the available molybdenum.

### Example 2

The relevant composition of the mineral body sample for Example 2 (IB-20) is illustrated in Table 6.

TABLE 6

Assay
(wt. %)

| | Cu | Mo | Fe | Mg |
|---|---|---|---|---|
| Example 2 | 0.86 | 0.021 | 13.20 | 2.60 |

This mineral body has the highest copper content of all of the mineral bodies disclosed in these examples.

For purposes of comparison, the final analysis of the recovered concentrate when subjected to an open cycle test is illustrated in Tables 7 and 8. The open cycle test of this Example 2 consisted of a single pass through a rougher flotation and 4 copper cleaner flotation steps to recover a copper concentrate.

TABLE 7

| | Cu/Mo Concentrate | | |
|---|---|---|---|
| | Analysis (wt. %) | | |
| | Cu | Mo | Insolubles |
| Example 2 | 18.40 | 0.350 | 27.10 |

TABLE 8

Final Cu/Mo
Concentrate
wt. %
Recovery

| | Cu | Mo |
|---|---|---|
| Example 2 | 92.74 | 60.19 |

About 92.7 wt. % of the available copper and about 60.2 wt. % of the available molybdenum is recovered in a concentrate that includes about 18.4 wt. % copper, about 0.4 wt. % molybdenum and about 27.1 wt. % insolubles.

The mineral body is also subjected to the method of the present invention. The dosage of CMC in the 2^{nd} and 3^{rd} cleaner flotation steps is 63 g/tonne. The results are illustrated in Tables 9 and 10.

TABLE 9

| | Analysis (wt. %) | | | | | |
|---|---|---|---|---|---|---|
| | | | 1^{st} | | | |
| | Final | | Cleaner Mo | | Mo Rougher Tail | |
| | Cu Concentrate | | Concentrate | | to Process Recycle | |
| | Cu | Mo | Cu | Mo | Cu | Mo |
| Example 2 | 24.5 | 0.01 | 0.79 | 0.805 | 2.42 | 0.08 |

TABLE 10

| | Distribution (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 2 | 91.22 | 3.14 | 0.84 | 72.15 | 1.84 | 5.13 |

The copper grade in the final copper concentrate was higher for the method of the present invention than for the open cycle test (24.5 wt. % vs. 18.4 wt. %), primarily due to the addition of CMC to depress flotation of MOS₂ and insolubles in the copper flotation circuit.

The copper concentrate initially recovered from the copper flotation circuit using the method of the present invention includes about 91 wt. % of the available copper. In addition, copper from the first cleaner molybdenum concentrate and the molybdenum rougher tail can be recycled back to the copper cleaner flotation circuit and most of the copper in these feeds (about 2.5 wt. % of the available copper) can also be recovered, resulting in a final copper concentrate that is at least comparable to or greater than the open cycle test, which recovered about 92.7 wt. % of the available copper.

The total molybdenum recovery according to the present invention is approximately the sum of the molybdenum recovered from the first cleaner molybdenum concentrate (about 72.2 wt. % of the available molybdenum) and from the molybdenum rougher tailings (about 5.1 wt. % of the available molybdenum), since the tailings are recycled back to the copper cleaner circuit and most of that molybdenum can be recovered. Thus, for this Example 2, the total molybdenum recovery can approach about 76 wt. % of the available molybdenum.

### Example 3

The relevant composition of the mineral body sample for Example 3 (I+20) is illustrated in Table 11.

TABLE 11

Assay
(wt. %)

| | Cu | Mo | Fe | Mg |
|---|---|---|---|---|
| Example 3 | 0.63 | 0.012 | 6.55 | 2.09 |

The copper and molybdenum content in this sample are close to the average when compared to the other samples. For purposes of comparison, the final analysis of the recovered concentrate when subjected to the locked cycle test is illustrated in Tables 12 and 13.

TABLE 12

| | Cu/Mo Concentrate | | |
|---|---|---|---|
| | Analysis (wt. %) | | |
| | Cu | Mo | Insolubles |
| Example 3 | 26.62 | 0.391 | 12.82 |

TABLE 13

Final Cu/Mo Concentrate
(wt. % Recovery)

| | Cu | Mo |
|---|---|---|
| Example 3 | 88.20 | 56.85 |

About 88.2 wt. % of the available copper and about 56.9 wt. % of the available molybdenum is recovered in a concentrate that includes about 26.6 wt. % copper, about 0.4 wt. % molybdenum and about 12.8 wt. % insolubles (e.g., gangue minerals).

The mineral body is also subjected to the molybdenum recovery method of the present invention. The dosage of CMC in the 2^{nd} and 3^{rd} cleaner flotation steps is 100 g/tonne. The results are illustrated in Tables 14 and 15.

TABLE 14

| | Analysis (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 3 | 35.3 | 0.062 | 2.00 | 1.17 | 2.62 | 0.059 |

TABLE 15

| | Distribution (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 3 | 86.24 | 9.5 | 1.73 | 63.63 | 3.84 | 5.42 |

The copper grade in the final copper concentrate is higher for the method of the present invention than for the locked cycle test (35.3 wt. % vs. 26.6 wt. %), primarily due to the addition of CMC to depress flotation of MOS₂ and insolubles in the copper flotation circuit.

The copper concentrate initially recovered from the copper flotation circuit using the method of the present invention includes about 86 wt. % of the available copper, as compared to about 88 wt. % of available copper in the locked cycle test. However, the copper from the first cleaner molybdenum concentrate and from the molybdenum rougher tail can be recycled back to the copper cleaner flotation circuit and substantially all of the copper in these feeds (about 5.5 wt. % total for Example 3) can subsequently be recovered, resulting in a final copper concentrate that is at least comparable to or greater than the locked cycle test.

Applying the method of the present invention, a portion of the molybdenum value is lost with the initial copper concentrate. About 64 wt. % of the molybdenum is recovered in the first cleaner molybdenum concentrate. In addition, the molybdenum rougher tailing (containing about 5 wt. % of the molybdenum) can be recycled to the copper flotation circuit, resulting in the recovery of most of that molybdenum. Therefore, the total molybdenum recovery can approach 68 wt. % to 69 wt. %. It is believed that increased molybdenum recovery could be achieved by increasing the dosage of CMC in the cleaner flotation steps.

### Example 4

The relevant composition of the mineral body sample for Example 4 (I-20) is illustrated in Table 16.

TABLE 16

Assay
(wt. %)

| | Cu | Mo | Fe | Mg |
|---|---|---|---|---|
| Example 4 | 0.63 | 0.034 | 8.45 | 2.15 |

The molybdenum content in this sample is the highest of all mineral bodies that are evaluated in these examples. For purposes of comparison, the final analysis of the recovered concentrate when subjected to the locked cycle test is illustrated in Tables 17 and 18.

TABLE 17

| | Cu/Mo Concentrate | | |
|---|---|---|---|
| | Analysis (wt. %) | | |
| | Cu | Mo | Insolubles |
| Example 4 | 24.03 | 0.047 | 18.46 |

TABLE 18

Final Cu/Mo Concentrate
(wt. % Recovery)

| | Cu | Mo |
|---|---|---|
| Example 4 | 92.13 | 2.94 |

About 92.1 wt. % of the available copper and about 2.9 wt. % of the available molybdenum is recovered in a concentrate that includes about 24 wt. % copper, about 0.05 wt. % molybdenum and about 18.5 wt. % insolubles (e.g., gangue minerals).

The mineral body is also subjected to the molybdenum recovery method of the present invention. The dosage of CMC in the 2^{nd} and 3^{rd} cleaner flotation is 124 g/tonne. The results are illustrated in Tables 19 and 20.

TABLE 19

| | Analysis (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 4 | 24.3 | 0.015 | 0.49 | 1.96 | 0.92 | 0.201 |

TABLE 20

| | Distribution (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 4 | 92.48 | 1.08 | 1.11 | 84.03 | 1.89 | 7.82 |

The copper concentrate initially recovered from the copper flotation circuit using the method of the present invention includes about 24.3 wt. % copper, as compared to about 24 wt. % copper in the locked cycle test.

The initial copper recovery for the method of the present invention is comparable to that of the locked cycle test at about 92 wt. %. However, the copper from the first cleaner molybdenum concentrate and from the molybdenum rougher tail can be recycled back to the copper cleaner flotation circuit and substantially all of the copper in these feeds (about 3 wt. % total for Example 4) can subsequently be recovered, resulting in a final copper recovery that is at least comparable to or higher than the locked cycle test.

Applying the method of the present invention, a very small portion of the available molybdenum value is lost with the initial copper concentrate. About 84 wt. % of the available molybdenum is recovered in the first cleaner molybdenum concentrate, which includes a concentration of about 1.96 wt. % molybdenum. In addition, the molybdenum rougher tailing (containing about 8 wt. % of the available molybdenum) can be recycled back to the copper flotation circuit, resulting in the recovery of most of that molybdenum. Therefore, the total molybdenum recovery can approach about 90 wt. % of the available molybdenum.

### Example 5

The relevant composition of the mineral body sample for Example 5 (SB+20) is illustrated in Table 21.

TABLE 21

Assay (wt. %)

| | Cu | Mo | Fe | Mg |
|---|---|---|---|---|
| Example 5 | 0.57 | 0.005 | 9.5 | 2.89 |

For this sample, the copper grade is slightly lower than average when compared to the other ore samples and the molybdenum content is the lowest of all samples that are evaluated herein. For purposes of comparison, the final analysis of the recovered concentrate when subjected to the locked cycle test is illustrated in Tables 22 and 23.

TABLE 22

| | Cu/Mo Concentrate | | |
|---|---|---|---|
| | Analysis (wt. %) | | |
| | Cu | Mo | Insolubles |
| Example 5 | 27.03 | 0.043 | 22.48 |

TABLE 23

Final Cu/Mo Concentrate
wt. % Recovery

| | Cu | Mo |
|---|---|---|
| Example 5 | 76.52 | 6.02 |

About 76.5 wt. % of the available copper and about 6 wt. % of the available molybdenum is recovered in a concentrate that includes about 27 wt. % copper, about 0.04 wt. % molybdenum and about 22.5 wt. % insolubles (e.g., gangue minerals).

The mineral body is also subjected to the molybdenum recovery method of the present invention. The dosage of CMC in the 2^{nd} and 3^{rd} cleaner flotation steps is 239 g/tonne. In this example, a 4^{th} cleaner flotation is used, also at a CMC dosage of 239 g/tonne. The results are illustrated in Tables 24 and 25.

TABLE 24

| | Analysis (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 5 | 26.8 | 0.027 | 3.63 | 0.429 | 1.46 | 0.016 |

TABLE 25

| | Distribution (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 5 | 77.47 | 6.7 | 7.38 | 74.84 | 4.14 | 3.89 |

The copper grade in the final copper concentrate for the method of the present invention is comparable to the copper grade for the locked cycle test, at about 27 wt. %.

The copper concentrate initially recovered from the copper flotation circuit using the method of the present invention includes about 77.5 wt. % of the available copper, similar to the 76.5 wt. % of available copper recovered in the locked cycle test. However, the copper from the first cleaner molybdenum concentrate and from the molybdenum rougher tail can be recycled back to the copper cleaner flotation circuit and most of the copper in these feeds (about 11.5 wt. % total for Example 5) can subsequently be recovered, resulting in a final copper recovery that is at least comparable to or higher than the locked cycle test.

Applying the method of the present invention, a very small portion of the molybdenum value is lost with the initial copper concentrate. About 74.8 wt. % of the available molybdenum is recovered in the first cleaner molybdenum concentrate. In addition, the molybdenum rougher tailing (containing about 3.9 wt. % of the available molybdenum) can be recycled back to the copper flotation circuit, resulting in the recovery of most of that molybdenum. Therefore, the total molybdenum recovery can approach 78 wt. %.

### Example 6

The relevant composition of the mineral body sample for Example 6 (SB-20) is illustrated in Table 26.

TABLE 26

Assay (wt. %)

| | Cu | Mo | Fe | Mg |
|---|---|---|---|---|
| Example 6 | 0.61 | 0.023 | 8.75 | 2.45 |

As compared to the other samples, the copper grade is close to the average in the molybdenum content in the sample is higher than average. For purposes of comparison, the final analysis of the recovered concentrate when subjected to a conventional locked cycle test is illustrated in Tables 27 and 28.

TABLE 27

| | Cu/Mo Concentrate | | |
|---|---|---|---|
| | Analysis (wt. %) | | |
| | Cu | Mo | Insolubles |
| Example 6 | 29.86 | 0.104 | 5.59 |

TABLE 28

Final Cu/Mo Concentrate
(wt. % Recovery)

| | Cu | Mo |
|---|---|---|
| Example 6 | 88.85 | 6.60 |

About 88.9 wt. % of the available copper and about 6.6 wt. % of the available molybdenum is recovered in a concentrate that includes about 29.9 wt. % copper, about 0.1 wt. % molybdenum and about 5.6 wt. % insolubles (e.g., gangue minerals).

The mineral body is also subjected to the molybdenum recovery method of the present invention. The dosage of CMC in the 2^{nd} and 3^{rd} cleaner flotation steps is 42 g/tonne. The results are illustrated in Tables 29 and 30.

TABLE 29

| | Analysis (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 6 | 29.5 | 0.06 | 2.87 | 6.15 | 2.53 | 0.258 |

TABLE 30

| | Distribution (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 6 | 88.14 | 4.09 | 1.64 | 80.02 | 2.19 | 5.11 |

The copper grade in the final copper concentrate is comparable for the method of the present invention and the locked cycle test at about 30 wt. %.

The copper concentrate initially recovered from the copper flotation circuit using the method of the present invention includes about 88.1 wt. % of the available copper, as compared to about 88.9 wt. % of available copper in the locked cycle test. However, the copper from the first cleaner molybdenum concentrate and from the molybdenum rougher tail can be recycled back to the copper cleaner flotation circuit and substantially all of the copper in these feeds (about 3.8 wt. % total for Example 6) can subsequently be recovered, resulting in a final copper recovery that is at least comparable to or higher than the locked cycle test.

Applying the method of the present invention, a very small portion of the molybdenum value is lost with the initial copper concentrate. About 80 wt. % of the available molybdenum is recovered in the first cleaner molybdenum concentrate. In addition, the molybdenum rougher tailing (containing about 5.1 wt. % of the available molybdenum) can be recycled to the copper flotation circuit, resulting in the recovery of most of that molybdenum. Therefore, the total molybdenum recovery can approach 84 wt. % of the available molybdenum.

### Example 7

The relevant composition of the mineral body sample for Example 7 (S+20) is illustrated in Table 31.

TABLE 31

Assay (wt. %)

| | Cu | Mo | Fe | Mg |
|---|---|---|---|---|
| Example 7 | 0.71 | 0.008 | 8.55 | 4.23 |

As compared to the other samples, the copper grade is higher than average and the molybdenum content in the sample is lower than average. For purposes of comparison, the final analysis of the recovered concentrate when subjected to a conventional locked cycle test is illustrated in Tables 32 and 33.

TABLE 32

| | Cu/Mo Concentrate | | |
|---|---|---|---|
| | Analysis (wt. %) | | |
| | Cu | Mo | Insolubles |
| Example 7 | 27.51 | 0.012 | 7.28 |

TABLE 33

Final Cu/Mo Concentrate
wt. % Recovery

| | Cu | Mo |
|---|---|---|
| Example 7 | 80.04 | 2.42 |

About 80 wt. % of the available copper and about 2.4 wt. % of the available molybdenum is recovered in a concentrate that includes about 27.5 wt. % copper, about 0.01 wt. % molybdenum and about 7.3 wt. % insolubles (e.g., gangue minerals).

The mineral body is also subjected to the molybdenum recovery method of the present invention. The dosage of CMC in the 2^{nd} and 3^{rd} cleaner flotation steps is 125 g/tonne. The results are illustrated in Tables 34 and 35.

TABLE 34

| | Analysis (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 7 | 25.4 | 0.003 | 1.47 | 0.21 | 1.36 | 0.034 |

TABLE 35

| | Distribution (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 7 | 79.19 | 1.16 | 3.14 | 55.82 | 2.57 | 8 |

The copper grade in the final copper concentrate is slightly lower for the method of the present invention than for the locked cycle test (25.4 wt. % vs. 27.5 wt. %).

The copper concentrate initially recovered from the copper flotation circuit using the method of the present invention includes about 79.2 wt. % of the available copper, as compared to about 80 wt. % of the available copper in the locked cycle test. However, the copper from the first cleaner molybdenum concentrate and from the molybdenum rougher tail can be recycled back to the copper cleaner flotation circuit and substantially all of the copper in these feeds (about 5.7 wt. % total for Example 7) can subsequently be recovered, resulting in a final copper concentrate that is at least comparable to or is greater than the locked cycle test.

Applying the method of the present invention, a very small portion of the molybdenum value is lost with the initial copper concentrate. About 55.8 wt. % of the molybdenum is recovered in the first cleaner molybdenum concentrate. In addition, the molybdenum rougher tailing (containing about 8 wt. % of the molybdenum) can be recycled to the copper flotation circuit, resulting in the recovery of most of that molybdenum. Therefore, the total molybdenum recovery can approach 63 wt. %.

### Example 8

The relevant composition of the mineral body sample for Example 8 (S-20) is illustrated in Table 36.

TABLE 36

| | Assay | | | | |
|---|---|---|---|---|---|
| | (wt. %) | | | | Soluble Cu |
| | Cu | Mo | Fe | Mg | (%) |
| Example 8 | 0.57 | 0.011 | 8.90 | 5.85 | 10.53 |

As compared to previous examples, the copper content is slightly lower and the magnesium content is the highest of all the samples, indicating a high level of talc.

For purposes of comparison, the final analysis of the recovered Cu/Mo concentrate when subjected to the locked cycle test is illustrated in Tables 37 and 38.

TABLE 37

| | Cu/Mo Concentrate | | |
|---|---|---|---|
| | Analysis (wt. %) | | |
| | Cu | Mo | Insolubles |
| Example 8 | 27.07 | 0.025 | 8.35 |

TABLE 38

Final Cu/Mo Concentrate
wt. % Recovery

| | Cu | Mo |
|---|---|---|
| Example 8 | 84.04 | 3.16 |

About 84 wt. % of the available copper and about 3.2 wt. % of the available molybdenum is recovered in a concentrate that includes about 27.1 wt. % copper, about 0.03 wt. % molybdenum and about 8.4 wt. % insolubles (e.g., gangue minerals).

The mineral body is also subjected to the molybdenum recovery method of the present invention. The dosage of CMC in the 2^{nd} and 3^{rd} cleaner flotation steps is 125 g/tonne. The results are illustrated in Tables 39 and 40.

TABLE 39

| | Analysis (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 8 | 24 | 0.006 | 0.24 | 0.172 | 0.67 | 0.058 |

TABLE 40

| | Distribution (wt. %) | | | | | |
|---|---|---|---|---|---|---|
| | | | | | Mo Rougher | |
| | Final Cu | | 1st Cleaner Mo | | Tail to | |
| | Concentrate | | Concentrate | | Process Recycle | |
| | Cu | Mo | Cu | Mo | Cu | Mo |
| Example 8 | 85.06 | 1.16 | 1.8 | 70.57 | 1.72 | 8.12 |

The copper grade in the final copper concentrate is lower for the method of the present invention than for the locked cycle test (24 wt. % vs. 27.1 wt. %).

The copper concentrate initially recovered from the copper flotation circuit using the method of the present invention includes about 85.1 wt. % of the available copper, as compared to about 84 wt. % of the available copper in the locked cycle test. However, the copper from the first cleaner molybdenum concentrate and from the molybdenum rougher tail can be recycled back to the copper cleaner flotation circuit and most of the copper in these feeds (about 3 wt. % total for Example 8) can subsequently be recovered, resulting in a final copper concentrate that is at least comparable to or greater than the locked cycle test.

Applying the method of the present invention, a very small portion of the molybdenum value is lost with the initial copper concentrate. About 70.6 wt. % of the available molybdenum is recovered in the first cleaner molybdenum concentrate. In addition, the molybdenum rougher tailing (containing about 8.1 wt. % of the available molybdenum) can be recycled to the copper flotation circuit, resulting in the recovery of most of that molybdenum. Therefore, the total molybdenum recovery can approach 76 wt. % to 78 wt. % of the available molybdenum.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A method for the separation and recovery of a molybdenum-bearing mineral from a mineral ore body, comprising the steps of:
(a) providing a mineral ore body comprising a base metal mineral and a molybdenum-bearing mineral;
(b) forming a mineral ore concentrate from said mineral ore body;
(c) subjecting said mineral ore concentrate to a base metal flotation step in the presence of a depressant, wherein said depressant depresses the flotation of said molybdenum-bearing mineral in said base metal flotation step;
(d) recovering tailings from said base metal flotation step wherein said tailings comprise said molybdenum-bearing mineral;
(e) activating said tailings, wherein said activating step changes a surface property of said molybdenum-bearing mineral; and
(f) subjecting said activated tailings to a first molybdenum flotation step wherein said molybdenum-bearing mineral is separated from said tailings to form a first molybdenum mineral concentrate.

2. A method as recited in claim 1, further comprising the step of:
(g) subjecting said first molybdenum mineral concentrate to a second molybdenum flotation step to separate silicates from said first molybdenum mineral concentrate and form a second molybdenum mineral concentrate.

3. A method as recited in claim 1, wherein said base metal mineral comprises a copper sulfide mineral.

4. A method as recited in claim 1, wherein said base metal mineral comprises a mineral selected from the group consisting of chalcocite, covellite, bornite, enargite, tennanite, tetrahedrite, digenite, chalcopyrite and combinations thereof.

5. A method as recited in claim 1, wherein said step of forming a mineral ore concentrate comprises comminuting said mineral ore body and subjecting the comminuted mineral ore body to rougher flotation.

6. A method as recited in claim 1, wherein said depressant comprises a polysaccharide.

7. A method as recited in claim 1, wherein said depressant comprises carboxy methyl cellulose.

8. A method as recited in claim 1, wherein said depressant comprises sodium carboxy methyl cellulose.

9. A method as recited in claim 1, wherein said activating step comprises heating said tailings in water.

10. A method as recited in claim 1, wherein said activating step comprises heating said tailings in water at a temperature of at least about 40° C.

11. A method as recited in claim 1, wherein said activating step comprises heating said tailings in water at a temperature of at least about 65° C. and not greater than about 95° C.

12. A method as recited in claim 9, wherein said activating step occurs at ambient pressure.

13. A method as recited in claim 1, wherein said mineral ore body further comprises sulfide minerals selected from the group consisting of sphalerite, maramtite, pyrite, galena, phyrrotite, pentlandite and millerite.

14. A method as recited in claim 1, wherein said molybdenum-bearing mineral comprises molybdenite.

15. A method as recited in claim 1, wherein said mineral ore body further comprises gangue minerals.

16. A method as recited in claim 15, wherein said gangue minerals comprise silicate minerals.

17. A method as recited in claim 16, wherein said mineral ore body comprises at least about 4 wt. % of said silicate minerals.

18. A method as recited in claim 16, wherein said gangue minerals comprise talc.

19. A method as recited in claim 16, wherein said gangue minerals are depressed during said base metal flotation step.

20. A method as recited in claim 2, further comprising the step of, after said first molybdenum flotation step and before said second molybdenum flotation step, adjusting the pH of said first molybdenum mineral concentrate to not greater than about pH 3.

21. A method as recited in claim 20, wherein said pH adjusting step comprises adding a sulfur-containing acid to said molybdenum mineral slurry.

22. A method as recited in claim 2, further comprising the steps of:
(g) roasting said second molybdenum mineral concentrate in the presence of an oxygen-containing gas to oxidize said molybdenum-bearing mineral; and
(h) subjecting said roasted molybdenum mineral concentrate to a third flotation step whereby silicate minerals are separated from said molybdenum-bearing mineral.

23. A method for the recovery of molybdenite from an ore body, comprising the steps of:
(a) providing an ore concentrate comprising a base metal sulfide mineral, molybdenite and a silicate mineral;
(b) subjecting said ore concentrate to a base metal flotation step in the presence of a depressant, wherein said depressant depresses flotation of said molybdenite and said silicate mineral in said base metal flotation step;
(c) recovering tailings from said base metal flotation step wherein said tailings comprise said molybdenite and said silicate mineral;
(d) activating said tailings, wherein said activating step renders said molybdenite floatable;
(e) subjecting said activated tailings to a first molybdenum flotation step wherein said molybdenite is separated from said tailings to form a first molybdenum concentrate;
(f) reducing the pH of said first molybdenum concentrate; and
(g) subjecting said first molybdenite concentrate to a second molybdenum flotation step to form a second molybdenum concentrate.

24. A method as recited in claim 23, wherein said silicate mineral is a layered silicate mineral.

25. A method as recited in claim 23, wherein said silicate mineral comprises talc.

26. A method as recited in claim 23, wherein said base metal sulfide mineral is a copper mineral.

27. A method as recited in claim 23, wherein said activating step comprises contacting said tailings with water at a temperature of at least about 40° C. and not greater than about 95° C.

28. A method as recited in claim 23, further comprising the steps of:
(h) roasting said second molybdenum concentrate in the presence of an oxygen-containing gas to oxidize said molybdenum-bearing mineral; and
(i) subjecting said roasted second molybdenum concentrate to a third flotation step whereby silicate minerals are separated from said molybdenum-bearing mineral.
